(19) United States
(12) Patent Application Publication
(10) Pub. No.: US 2010/0153759 A1
(43) Pub. Date: Jun. 17, 2010

(54) POWER GATING TECHNIQUE TO REDUCE POWER IN FUNCTIONAL AND TEST MODES

(76) Inventor: RAKSHIT SINGHAL, Bangalore (IN)

Correspondence Address: Raj Abhyanker LLP, 1580 West, El Camino Real, Suite 8, Mountain View, CA, 94040, US

(21) Appl. No.: 12/334,554

(22) Filed: Dec. 15, 2008

(51) Int. Cl. G06F 1/28; G06F 1/32

(52) U.S. Cl. 713/322; 713/330; 713/320

(57) ABSTRACT

A method and apparatus of a power gating technique to reduce power in functional and test modes are disclosed. In one embodiment, a method includes separating a power domain of a module to two distinctive sets of sub-power domains, powering a combinational logic with one of the two distinctive sets of power domains, and powering a sequential logic with the other of the two distinctive sets of power domains. The method may reduce an active and leakage power in a functional mode by gating power of the combinational logic and not gating power of the sequential logic. A system state may be retained in the sequential logic because the sequential logic remains powered during the functional mode without requiring a retention flop, an on-chip memory and/or an off-chip memory. A wake up time of the module may be reduced through the retention of the system state in the sequential logic.

### FIELD OF TECHNOLOGY

This disclosure relates generally to power management technology, and more particularly to a power gating technique to reduce power in functional and test modes.

### BACKGROUND

A power gating technique may be used to reduce an active and leakage power consumption in a device (e.g., an integrated circuit). However, once a module of the device (e.g., a logic of the device) is power gated, data stored in registers of the device may be lost. Extra hardware (e.g., on chip retention flops, an on-chip memory, an off-chip memory) may be used for data retention. The extra hardware may be expensive and/or take up constrained die area and/or consume extra power. Storing a system state into a memory and then restoring the state back once the power is restored may be slow if the system state is stored in internal and/or external memories. Alternatively, a scan structure of another power gated block may be used to store the system state. However, this method may be too slow for a high-performance system (e.g., shifting the system state to through scan path into a scan chain may be time consuming). Registers of the device can also be implemented as retention flops at the cost of additional silicon area so as to retain the system state. However, this may also cause an area overhead that might be prohibitive at times.

A scan-based testing may involve testing interconnects (e.g., thin wire lines) on a module (e.g., a logic circuit) of a device (e.g., a laptop, a mobile phone, an integrated circuit, etc.) without using a physical test probe. The scan-based testing may consume extensive power (e.g., high test power). For example, an increased activity during scan shift of test patterns may result in a test power that exceeds the total functional power specification of the device.

A reduced frequency may be used to shift the test pattern into the device so that the test power can be reduced by controlling an activity (e.g., operation) of the device. The reduced test frequency may result in a longer test application time. The longer test application time may increase cost of the scan-based testing (e.g., additional resources may be required and efficiency may be reduced).

### SUMMARY

A method, system, and apparatus of a power gating technique to reduce power in functional and test modes are disclosed. In one aspect, a method includes separating a power domain of a module to two distinctive sets of sub-power domains, powering a combinational logic with one of the two distinctive sets of power domains, and powering a sequential logic with the other of the two distinctive sets of power domains. The method may reduce an active and leakage power in a functional mode by gating power of the combinational logic and not gating power of the sequential logic. A system state may be retained in the sequential logic because the sequential logic remains powered during the functional mode without requiring a retention flop, an on-chip memory and/pr an off-chip memory. A wake up time of the module may be reduced through the retention of the system state in the sequential logic.

A clock of the sequential logic may be disabled during a power down sequence. A scan enable signal of a scan multiplexer in the sequential logic may be activated. A known value may be captured through a feed forward path of the scan multiplexer after disabling the clock. Power may be removed to the combinational logic after disabling the clock and activating the scan enable signal.

Power may be applied to the combinational logic during a power up sequence. Then, the scan enable signal of the sequential logic may be deactivated after applying power to the combinational logic. A clock of the sequential logic may be enabled after applying power to the combinational logic and deactivating the scan enable signal.

Power may be removed to the combinational logic during a scan shift during a test operation while retaining power to the sequential logic. However, power may be applied to the combinational logic during a scan capture of the test operation.

A simulation time of an Automated Test Equipment (ATE) test pattern may be reduced if the test patterns are simulated with a power aware simulation. A power system specification may define the set of combinational logic to be powered off during the scan shift. A toggle activity of the combinational logic will not be seen in a simulation during the scan shift. The simulation time of the ATE test pattern may be reduced between 70% and 90% when the set of combinational logic is entirely gated during the scan shift.

A voltage of the sequential logic may be increased to account for speed degradation of a critical path of the module.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a circuit view of a module illustrating a typical scan chain having scan flops, according to one embodiment.

FIG. 2 illustrates an implementation flow to separate power domains of a combinational logic and a sequential logic, according to one embodiment.

FIG. 3 illustrates a power down sequence of the module, according to one embodiment.

FIG. 4 illustrates a power up sequence of the module, according to one embodiment.

FIG. 5 illustrates a test operation of the module, according to one embodiment.

FIG. 6 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

A method, system, and apparatus of a power gating technique to reduce power in functional and test modes are disclosed. Although the present embodiments have been described with reference to specific example embodiments, it will be evident that various modifications and changes may be made to these embodiments without departing from the broader spirit and scope of the various embodiments.

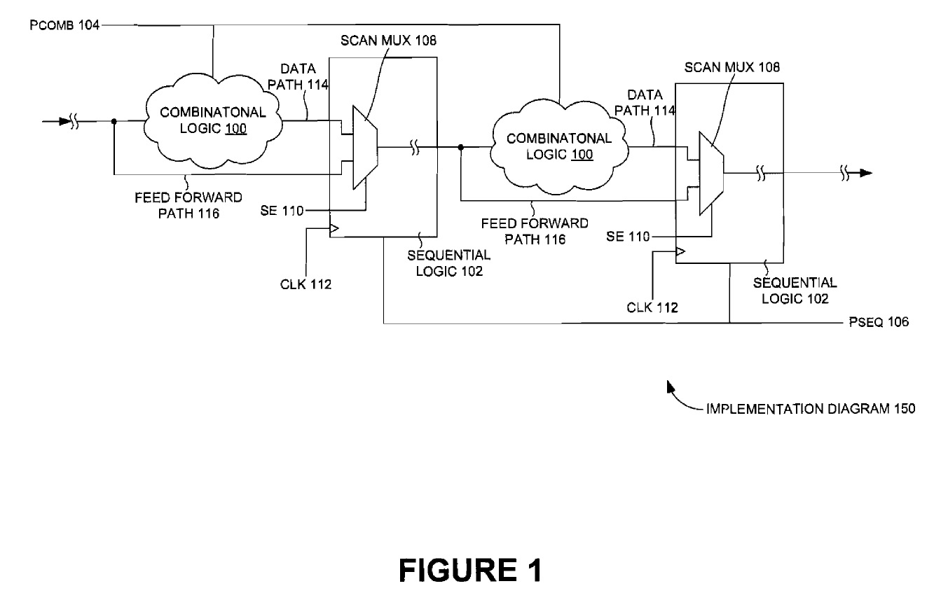

FIG. 1 is a circuit view of a module illustrating a typical scan chain having scan flops, according to one embodiment. Particularly, FIG. 1 illustrates a combinational logic 100, a sequential logic 102, a PCOMB 104, a PSEQ 106, a scan mux 108, a SE 110, a clk 112, a data path 114, a feed forward path 116, and an implementation diagram 150, according to one embodiment.

The implementation diagram 150 may be an electronic device (e.g., an integrated circuit, a laptop, a mobile phone, etc.) that may use the scan-based testing mechanism which may involve testing of interconnect (e.g., thin wire lines). The combinational logic 100 may be type of logic circuit (e.g., AND gate, OR gate, NOT gate, etc) whose output is a pure function of the present applied input. The sequential logic 102 may be a type of logic circuit (e.g., the flip-flops, the counters, etc) whose output depends on the present input and on the history of the input (e.g., previous applied input). The PCOMB 104 may be a signal that may power the combinational logic 100 with one distinctive set of the power domain. The PSEQ 106 may be a signal that may power the sequential logic 102 with another distinctive set of the power domain.

The scan mux 108 may be a multiplexer which may be a logic circuit device that may select one of many signals (e.g., analog signals, digital signals, etc) and may output that into a single line. The scan enable (SE) 110 may be a signal that may be given to select line of the multiplexer (e.g., the clamp cell) that may enable a power down block to prevent its output from going to unknown state and/or corrupting data. The clock (clk) 112 may be a signal (e.g., the input signal) that may change the output of the sequential logic 102 (e.g., the flip-flop, counter, etc.) on its rising edge and/or the falling edge. The data path 114 may be the signal which may be given to the scan mux 108 (e.g., the clamp cell) that may reduce a crowbar current and/or a leakage current when the control signal may be applied.

The feed forward path 116 may be another input signal given to the scan mux 108 (e.g., the clamp cell) that may drive the sequential logic 102.

In an example embodiment, the implementation diagram 150 may include the combinational logic 100 and the sequential logic 102. The PCOMB 104 may be the power domain that may power the combinational logic 100. The PSEQ 106 may be the power domain that may power the sequential logic 102. The feed forward path 116 and the data path 114 may be the input signal to the scan mux 108. The SE 110 may be select line signal given to the scan mux 108. The clk 112 may be the signal that is given to the sequential logic 102. The sequential logic 102 may include the scan mux 108.

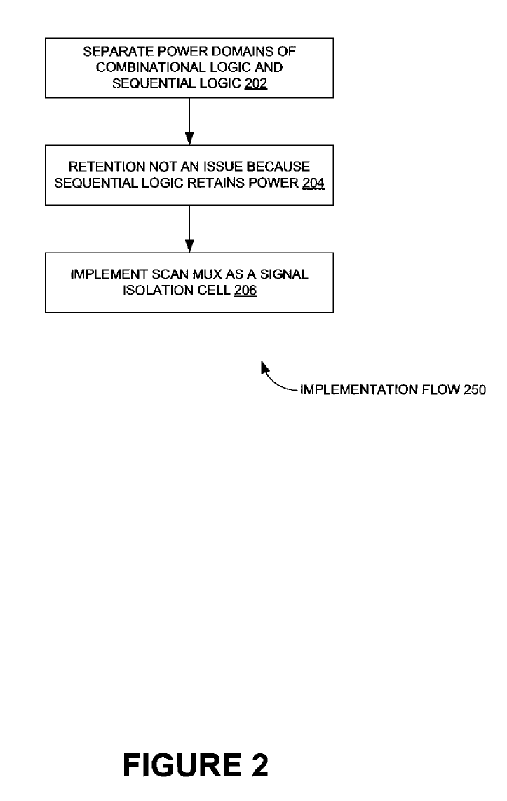

FIG. 2 illustrates an implementation flow to separate power domains of a combinational logic and a sequential logic, according to one embodiment.

The implementation flow 250 may illustrate the flow of the implementation diagram 150. In operation 202, the power domains of combinational logic 100 and sequential logic 102 may be separated into two distinctive sets of sub-power domains (e.g., PCOMB 104 for combinational logic 100 and PSEQ 106 for sequential logic 102). In operation 204, the separate power domains may retain the states of flip-flop of the sequential logic 102 because the sequential logic 102 remains powered during the functional mode without requiring any retention flop, an on-chip memory and an off-chip memory. The sequential logic 102 may retain power which may reduce the wake up time of the module through retention of the system state in the sequential logic 102. In operation 206, the implementation flow may implement the scan mux 108 as a signal isolation cell in the sequential logic 102 so as to remove the effect of an unwanted signal when power is removed from the combinational logic 100.

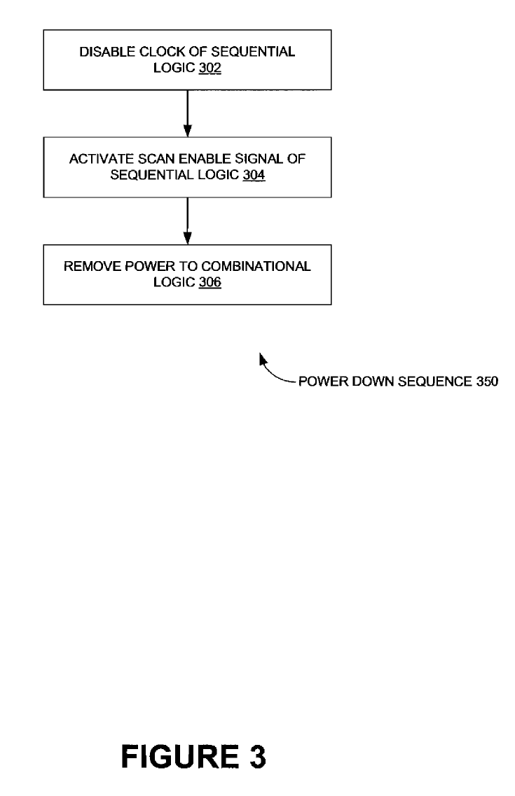

FIG. 3 illustrates a power down sequence of the module, according to one embodiment. Particularly, the power down sequence 350 of the implementation diagram 150 is illustrated, according to one embodiment. In operation 302, clock (e.g., the clk 112) of sequential logic 102 may disable the operation of the sequential logic 102. In operation 304, the scan enable signal (e.g., the SE 110) of sequential logic 102 may be activated and a known value may be captured through a feed forward path 116 of the scan multiplexer (e.g., the scan mux 108). In operation 306, the power to combinational logic 100 may be removed during a power saving mode which may also reduce a switching power and a leakage power when the combinational logic control signal is enabled. The power down sequence may isolate the data path 114 from corrupting data in flops. Now we can safely power down all combinational logic in the block.

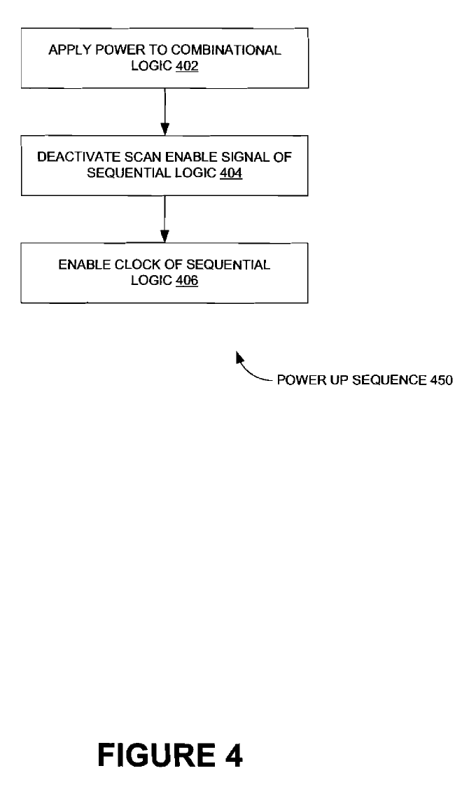

FIG. 4 illustrates a power up sequence of the module, according to one embodiment. Particularly, the power up sequence 450 of the implementation diagram 150 may be illustrated, according to one embodiment. In operation 402, the power to combinational logic 100 may be applied. In operation 404, the scan enable signal (e.g., the SE 110) of sequential logic 102 may be deactivated for power gating to reduce power in functional mode. In operation 406, the clock (e.g., the CLK 112) of sequential logic 102 may enable the sequential logic 102 to start operating. During power up sequence since all the states were still retained in flops the normal functional operation of the module can safely be resumed.

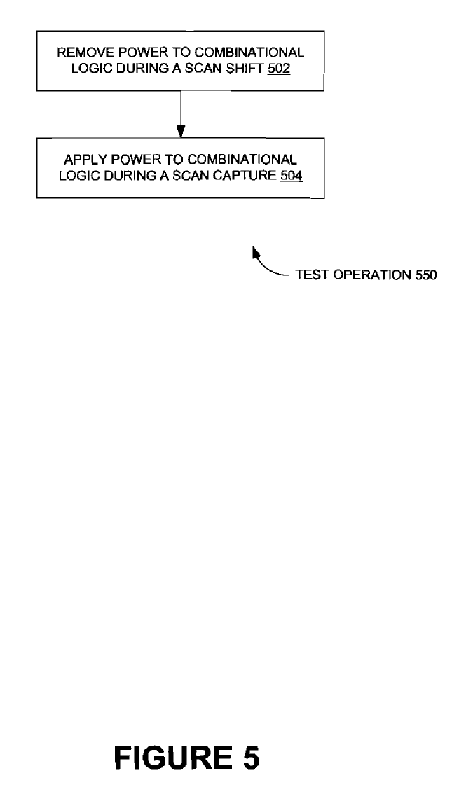

FIG. 5 illustrates a test operation of the module, according to one embodiment. Particularly, FIG. 5 illustrates the test operation 550 of the implementation diagram 150, according to one embodiment. In operation 502, the power to combinational logic 100 may be removed during a scan shift which may retain the power to the sequential logic 102 and also reduce the simulation time of an Automated Test Equipment (ATE) test pattern if the test patterns are simulated with a power aware simulation. In operation 504, the power may be applied to combinational logic 100 during a scan capture to reduce power in test modes.

For example, in scan vector simulation, more than 90 percent of the simulation time may be spend in just loading and unloading the test vector into the scan chains. Here the large toggle activity in combinational logic 100 slows down simulation drastically. The power aware simulator knowing that all combinational logic 100 is power gated will not see any toggle activity in the combinational logic 100 during scan shift and the simulation time can be reduced by as much as 70-90 percent.

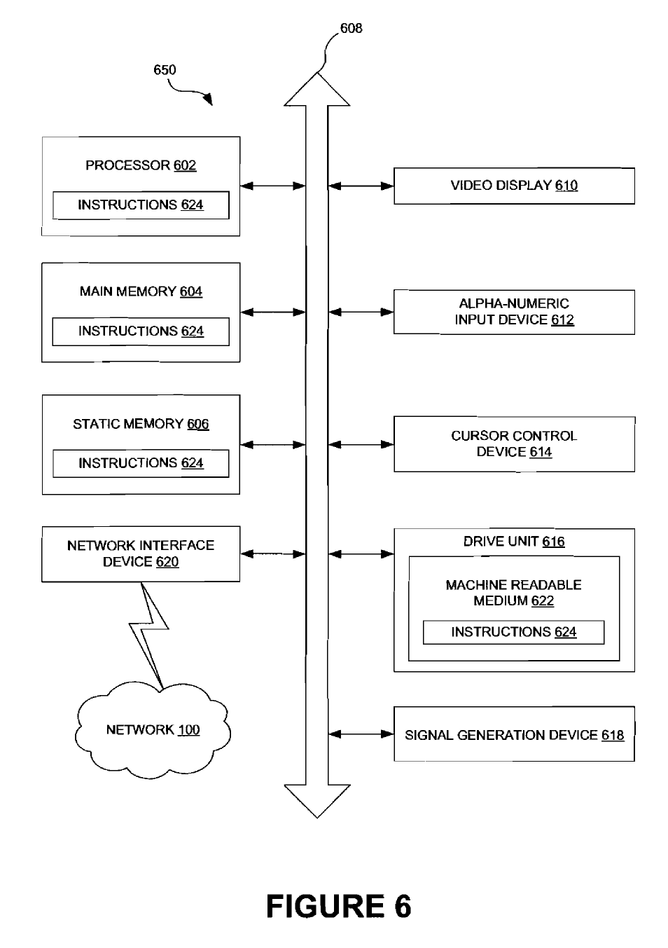

FIG. 6 is a diagrammatic system view of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or the data processing system in which one or more operations disclosed herein are performed. The processor 602 may be a microprocessor, a state machine, an application specific integrated circuit, a field programmable gate array, etc. (e.g., Intel® Pentium® processor). The main memory 604 may be a dynamic random access memory and/or a primary memory of a computer system.

The static memory 606 may be a hard drive, a flash drive, and/or other memory information associated with the data processing system. The bus 608 may be an interconnection between various circuits and/or structures of the data processing system. The video display 610 may provide graphical representation of information on the data processing system. The alpha-numeric input device 612 may be a keypad, a keyboard and/or any other input device of text (e.g., a special device to aid the physically handicapped).

The cursor control device 614 may be a pointing device such as a mouse. The drive unit 616 may be the hard drive, a storage system, and/or other longer term storage subsystem. The signal generation device 618 may be a bios and/or a functional operating system of the data processing system. The network interface device 620 may be a device that performs interface functions such as code conversion, protocol conversion and/or buffering required for communication to and from the network 626. The machine readable medium 622 may provide instructions on which any of the methods disclosed herein may be performed. The instructions 624 may provide source code and/or data code to the processor 602 to enable any one or more operations disclosed herein.

In one embodiment, the power domain of the module may be separated to a distinctive a set of sub-power domains. The power (e.g., the PCOMB 104) of a combinational logic 100 may be gated with a combinational logic control signal in one of the set of sub-power domains. The power (e.g., the PSEQ) of a sequential logic 102 may be gated with a sequential logic control signal in another of the set of sub-power domains. The switching power and a leakage power may be reduced when the combinational logic control signal is enabled and power is removed from the combinational logic 100 during a power saving mode. The data in the sequential logic 102 may be retained by retaining power to the sequential logic 102 during the power saving mode. The scan multiplexer (e.g., the scan mux 108) in the sequential logic 102 may be implemented as a signal isolation cell so as to remove effect of an unwanted signal when power is removed from the combinational logic 100.

The clock (e.g., the clk 112) of the sequential logic 102 may be disabled during a power down sequence. The scan enable signal (e.g., the SE 110) of a scan multiplexer (e.g., the scan mux 108) may be activated in the sequential logic 102 and capturing a known value through a feed forward path 116 of the scan multiplexer (e.g., the scan mux 108) after disabling the clock (e.g., the clk 112). The power to the combinational logic 100 may be removed after disabling the clock (e.g., the clk 112) and activating the scan enable signal (e.g., the SE 110).

The power to the combinational logic 100 may be applied during a power up sequence. The scan enable signal (e.g., the SE 110) of the sequential logic 102 may be deactivated after applying power to the combinational logic 100. The clock (e.g., the clk 112) of the sequential logic 102 may be enabled after applying power to the combinational logic 100 and deactivating the scan enable (e.g., the SE 110) signal. The power to the combinational logic 100 may be removed during a scan shift during a test operation while retaining power to the sequential logic 102.

The power to the combinational logic 100 may be applied during a scan capture of the test operation. The simulation time of an Automated Test Equipment (ATE) test pattern may be reduced if the test patterns are simulated with a power aware simulation. The power system specification defines the combinational logic 100 to be powered off during the scan shift. The toggle activity of the combinational logic 100 will not be seen in a simulation during the scan shift. The simulation time of the ATE test pattern may be reduced between 70% and 90% when the combinational logic 100 is entirely gated during the scan shift. The method may implement the scan multiplexer as an isolation cell such that the combinational logic can be powered off safely when the scan enable is active.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In particular, the combinational logic 100, the sequential logic 102, the scan mux 108 and the clock (C) 112, of FIG. 1 may be enabled using software and/or using transistors, logic gates, and electrical circuits (e.g., application specific integrated ASIC circuitry) such as a sequential circuit, a combinational circuit, a clock circuit, a scan mux circuit, a flip-flop circuit and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
separating a power domain of a module to two distinctive sets of sub-power domains;
powering a combinational logic with one of the two distinctive sets of power domains; and
powering a sequential logic with the other of the two distinctive sets of power domains.

2. The method of claim 1 further comprising:
reducing an active and leakage power in a functional mode by gating power of the combinational logic and not gating power of the sequential logic.

3. The method of claim 2 further comprising:
retaining a system state in the sequential logic because the sequential logic remains powered during the functional mode without requiring any of a retention flop, an on-chip memory and an off-chip memory; and
reducing a wake up time of the module through the retention of the system state in the sequential logic.

4. The method of claim 1 further comprising:
implementing the scan multiplexer as an isolation cell such that the combinational logic can be powered off safely when the scan enable is active.

5. The method of claim 1 further comprising:
disabling a clock of the sequential logic during a power down sequence;
activating a scan enable signal of a scan multiplexer in the sequential logic and capturing a known value through a feed forward path of the scan multiplexer after disabling the clock;
removing power to the combinational logic after disabling the clock and activating the scan enable signal.

6. The method of claim 5 further comprising:
applying power to the combinational logic during a power up sequence;
deactivating the scan enable signal of the sequential logic after applying power to the combinational logic; and
enabling the clock of the sequential logic after applying power to the combinational logic and deactivating the scan enable signal;
removing power to the combinational logic during a scan shift during a test operation while retaining power to the sequential logic; and
applying power to the combinational logic during a scan capture of the test operation.

7. The method of claim 6 further comprising:
reducing a simulation time of an Automated Test Equipment (ATE) test pattern if the test patterns are simulated with a power aware simulation, wherein
a power system specification defines the combinational logic to be powered off during the scan shift,
wherein a toggle activity of the combinational logic will not be seen in a simulation during the scan shift, and
wherein the simulation time of the ATE test pattern is reduced between 70% and 90% when the combinational logic is entirely gated during the scan shift.

8. A method, comprising:
separating a power domain of a module to a distinctive a set of sub-power domains;
gating power of a combinational logic with a combinational logic control signal in one of the set of sub-power domains;
gating power of a sequential logic with a sequential logic control signal in another of the set of sub-power domains; and
reducing at least one of a switching power and a leakage power when the combinational logic control signal is enabled and power is removed from the combinational logic during a power saving mode.

9. The method of claim 8 further comprising:
retaining a data in the sequential logic by retaining power to the sequential logic during the power saving mode; and
implementing a scan multiplexer in the sequential logic as a signal isolation cell so as to remove effect of an unwanted signal when power is removed from the combinational logic.

10. The method of claim 8 further comprising:
disabling a clock of the sequential logic during a power down sequence;
activating a scan enable signal of a scan multiplexer in the sequential logic and capturing a known value through a feed forward path of the scan multiplexer after disabling the clock;
removing power to the combinational logic after disabling the clock and activating the scan enable signal.

11. The method of claim 10 further comprising:
applying power to the combinational logic during a power up sequence;
deactivating the scan enable signal of the sequential logic after applying power to the combinational logic; and
enabling a clock of the sequential logic after applying power to the combinational logic and deactivating the scan enable signal.

12. The method of claim 11 further comprising:
removing power to the combinational logic during a scan shift during a test operation while retaining power to the sequential logic; and
applying power to the combinational logic during a scan capture of the test operation.

13. The method of claim 12 further comprising:
reducing a simulation time of an Automated Test Equipment (ATE) test pattern if the test patterns are simulated with a power aware simulation,
wherein a power system specification defines the combinational logic to be powered off during the scan shift, and
wherein a toggle activity of the combinational logic will not be seen in a simulation during the scan shift.

14. The method of claim 13 wherein the simulation time of the ATE test pattern is reduced between 70% and 90% when the combinational logic is entirely gated during the scan shift.

15. The method of claim 8 further comprising:
implementing the scan multiplexer as an isolation cell such that the combinational logic can be powered off safely when the scan enable is active.

16. A integrated circuit device, comprising:
a first power domain providing power to a combinational logic; and
a second power domain providing power to a sequential logic,
wherein an active and leakage power in a functional and a test mode is reduced by gating power of the combinational logic and not gating power of the sequential logic in a power saving mode.

17. The integrated circuit device of claim 16 further comprising:
a signal isolation cell implemented using a scan multiplexer of the sequential logic so as to remove effect of an unwanted signal when power is removed from the combinational logic.

18. The integrated circuit device of claim 16 wherein a power down sequence of the integrated circuit to:
disable a clock of the sequential logic during the power down sequence,
activate a scan enable signal of a scan multiplexer in the sequential logic and capture a known value through a feed forward path of the scan multiplexer after disabling the clock, and
remove power to the combinational logic after disabling the clock and activating the scan enable signal.

19. The integrated circuit device of claim 18 wherein a power up sequence of the integrated circuit to:
apply power to the combinational logic during the power up sequence,
deactivate the scan enable signal of the sequential logic after applying power to the combinational logic, and
enable the clock of the sequential logic after applying power to the combinational logic and deactivating the scan enable signal.

20. The integrated circuit device of claim 18 wherein a power system specification defines the combinational logic to be powered off during a scan shift.
